(19) United States
(12) Patent Application Publication
(10) Pub. No.: US 2019/0194454 A1
(43) Pub. Date: Jun. 27, 2019

(54) Compound, Cationic Curing Agent, and Cationic Curable Composition

(71) Applicant: Dexerials Corporation, Tokyo (JP)

(72) Inventors: Takeshi Nishio, Tokyo (JP); Kazunobu Kamiya, Tokyo (JP); Keisuke Morita, Tokyo (JP)

(21) Appl. No.: 16/219,178

(22) Filed: Dec. 13, 2018

(30) Foreign Application Priority Data
Dec. 21, 2017 (JP) 2017-244877

(51) Int. Cl. C08L 75/02; C08L 57/00; C07F 7/08; C08K 5/5419; C08K 5/56; C08K 3/36

(52) U.S. Cl. CPC C08L 75/02; C08L 57/00; C07F 7/0836; C08L 2312/08; C08K 5/56; C08K 3/36; C08K 5/5419

(57) ABSTRACT

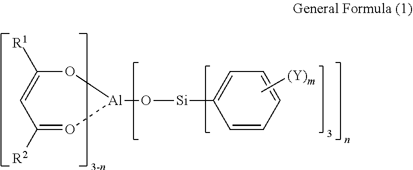

where R¹ is a C1-18 alkyl group, a C1-18 halogenated alkyl group, or a phenyl group that may include a substituent, R² is a C1-18 alkyl group, a C1-18 halogenated alkyl group, a C1-18 alkoxy group, or a phenyl group that may include a substituent, where R¹ and R² may be linked together to form a ring, Y is a halogen atom, a C1-18 alkyl group, a C1-18 halogenated alkyl group, or a phenyl group that may include a substituent, m is an integer of 0 to 5, where Ys may be identical or different when m is 2 or more, and n is an integer of 1 to 3.

### CROSS REFERENCE TO RELATED APPLICATIONS

The present application claims priority to Japanese Patent Application No. 2017-244877, filed on Dec. 21, 2017 and incorporated herein by reference.

### BACKGROUND OF THE INVENTION

### Field of the Invention

The present invention relates to a compound, a cationic curing agent, and a cationic curable composition.

### Description of the Related Art

As a method for cationic curing of an epoxy resin, a method using an aluminium chelate compound and a silanol compound in combination as catalysts has been known. According to this method, the aluminium chelate compound and the silanol compound are reacted with each other to generate cationic curing initiation species to realize cationic curing.

One example of a technique associated with a latent curing agent using the above-described curing system is a method where an aluminium chelate compound is held in porous particles. For example, the following techniques have been proposed.

Proposed is a method where an aluminium compound and a silanol compound are physically separated from each other by making the aluminium compound held inside porous particles produced using polyfunctionial isocyanate (see, for example, Japanese Patent Application Laid-Open (JP-A) No. 2009-203477).

As an example similar to the above-proposed technique, moreover, proposed is a method where difunctional isocyanate is used in combination with polyfunctional isocyanate to enhance curing performance (see, for example, JP-A No. 2012-188596).

Moreover, proposed is a method where a radical polymerizable compound is further used in combination at the time when porous particles are produced (see, for example, JP-A No. 2009-221465).

Furthermore, proposed is a method where porous inorganic particles are used as porous particles (see, for example, JP-A No. 2013-100382).

As a method for further improving latent characteristics from the above-described methods, moreover, proposed is, for example, a method where surfaces of porous particles are treated with a certain silane treating agent (see, for example, JP-A No. 2016-056274).

All of the above-proposed methods are methods for making an aluminium chelate compound latent and it is an assumption that cationic curing is controlled by a state of porous particles for use. There is however a problem that control of curing activity and latent characteristics by designing porous particles has a trade-off relationship because of principles of both properties.

### SUMMARY OF THE INVENTION

The present invention aims to solve the above-described various problems existing in the art and to achieve the following object. Specifically, the present invention has an object to provide a novel compound usable for a cationic curing agent that can improve curing performance without impairing latent characteristics, provide a cationic curing agent that can improve curing performance without impairing latent characteristics, and provide a cationic curable composition using the cationic curing agent.

The means for solving the above-described problems are as follows.
<1> A compound represented by General Formula (1) below:

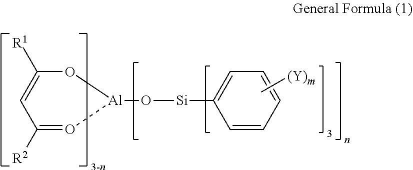

where, in General Formula (1), R¹ is an alkyl group having 1 to 18 carbon atoms, a halogenated alkyl group having 1 to 18 carbon atoms, or a phenyl group that may include a substituent, R² is an alkyl group having 1 to 18 carbon atoms, a halogenated alkyl group having 1 to 18 carbon atoms, an alkoxy group having 1 to 18 carbon atoms, or a phenyl group that may include a substituent, where R¹ and R² may be linked together to form a ring, Y is a halogen atom, an alkyl group having 1 to 18 carbon atoms, a halogenated alkyl group having 1 to 18 carbon atoms, or a phenyl group that may include a substituent, m is an integer of 0 to 5, where Ys may be identical or different when m is 2 or more, and n is an integer of 1 to 3.

<2> A cationic curing agent including:
porous particles; and
the compound according to <1>, held in the porous particles.
<3>The cationic curing agent according to <2>,
wherein a material of the porous particles includes a polyurea resin.
<4>The cationic curing agent according to <3>,
wherein the material of the porous particles further includes a vinyl resin.
<5>The cationic curing agent according to <2>,
wherein the porous particles are porous inorganic particles.
<6>The cationic curing agent according to any one of <2>to <5>,
wherein surfaces of the porous particles include a reaction product of a silane coupling agent.
<7>A cationic curable composition comprising:
a cationic curable component; and
the cationic curing agent according to any one of <2>to <6>.
<8>The cationic curable composition according to <7>, further including a compound represented by General Formula (B) below:

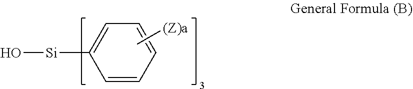

where in General Formula (B), Z is an electron-withdrawing group and a is an integer of 0 to 5.

The present invention can solve the above-described various problems existing in the art and to achieve the following object, and can provide a novel compound usable for a cationic curing agent that can improve curing performance without impairing latent characteristics, a cationic curing agent that can improve curing performance without impairing latent characteristics, and a cationic curable composition using the cationic curing agent.

### DESCRIPTION OF THE EMBODIMENTS

### (Compound)

A compound of the present invention is represented by General Formula (1) below.

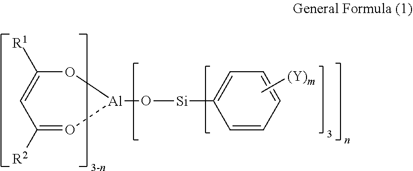

In General Formula (1), R¹ is an alkyl group having 1 to 18 carbon atoms, a halogenated alkyl group having 1 to 18 carbon atoms, or a phenyl group that may include a substituent, R² is an alkyl group having 1 to 18 carbon atoms, a halogenated alkyl group having 1 to 18 carbon atoms, an alkoxy group having 1 to 18 carbon atoms, or a phenyl group that may include a substituent, where R¹ and R² may be linked together to form a ring, Y is a halogen atom, an alkyl group having 1 to 18 carbon atoms, a halogenated alkyl group having 1 to 18 carbon atoms, or a phenyl group that may include a substituent, m is an integer of 0 to 5, where Ys may be identical or different when m is 2 or more, and n is an integer of 1 to 3.

In General Formula (1), an Al ligand including R¹ and R² is a so-called β-keto enolate anion, and R¹ and R² are not particularly limited and may be appropriately selected depending on the intended purpose, as long as R¹ and R² are substituents applicable for aluminium chelate using the β-keto enolate anion.

In view of applicability to the aluminium chelate, as R¹, an alkyl group having 1 to 18 carbon atoms, a halogenated alkyl group having 1 to 18 carbon atoms, or a phenyl group that may include a substituent can be used. As R², moreover, an alkyl group having 1 to 18 carbon atoms, a halogenated alkyl group having 1 to 18 carbon atoms, an alkoxy group having 1 to 18 carbon atoms, or a phenyl group that may include a substituent can be used. Moreover, R¹ and R² may be linked with each other to form a ring.

Since the A1 ligand including R¹ and R² is a so-called β-keto enolate anion, the A1 ligand may have a resonance structure. Therefore, General Formula (1) above is synonymous with General Formula (1-1) below and General Formula (1-2) below.

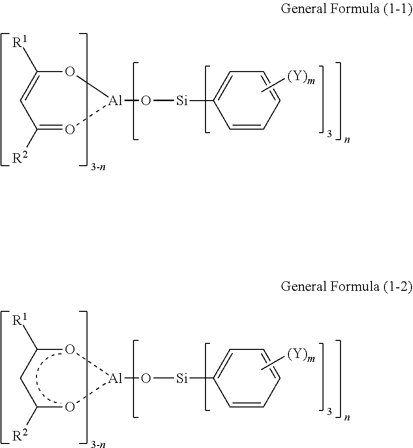

In General Formula (1), the segment of —O—Si-[Ph-(Y)m]₃ [Ph is a phenyl group] is a segment derived from aryl silanol, Y is a halogen atom, an alkyl group having 1 to 18 carbon atoms, a halogenated alkyl group having 1 to 18 carbon atoms, or a phenyl group that may include a substituent, and m is an integer of 0 to 5. When m is 2 or larger, a plurality of Ys may be identical or different.

As Y, for example, an electron-withdrawing group can be also used.

The alkyl group having 1 to 18 carbon atoms of R¹, R², and Y is not particularly limited and may be appropriately selected depending on the intended purpose. The alkyl group having 1 to 18 carbon atoms is preferably an alkyl group having 1 to 10 carbon atoms, more preferably an alkyl group having 1 to 6 carbon atoms, and particularly preferably an alkyl group having 1 to 3 carbon atoms.

The alkyl group having 1 to 18 carbon atoms may be in the form of a straight chain or a branched chain.

The halogenated alkyl group having 1 to 18 carbon atoms of R¹, R², and Y is not particularly limited and may be appropriately selected depending on the intended purpose. The halogenated alkyl group having 1 to 18 carbon atoms is preferably a halogenated alkyl group having 1 to 10 carbon atoms, more preferably a halogenated alkyl group having 1 to 6 carbon atoms, and particularly preferably a halogenated alkyl group having 1 to 3 carbon atoms.

Examples of a halogen atom in the halogenated alkyl group having 1 to 18 carbon atoms include a fluorine atom, a chlorine atom, a bromine atom, and an iodine atom.

A substituted position and the substituted number of halogen(s) in the halogenated alkyl group having 1 to 18 carbon atoms are not particularly limited and may be appropriately selected depending on the intended purpose.

The halogenated alkyl group having 1 to 18 carbon atoms may be in the form of a straight chain or a branched chain.

A substituent in the phenyl group that may include a substituent of R¹, R², and Y is not particularly limited and may be appropriately selected depending on the intended purpose. Examples of the substituent include an alkyl group having 1 to 18 carbon atoms, an alkoxy group having 1 to 18 carbon atoms, and a halogen atom. Examples of the halogen atom include a fluorine atom, a chlorine atom, a bromine atom, and an iodine atom.

The alkoxy group having 1 to 18 carbon atoms of R² is not particularly limited and may be appropriately selected depending on the intended purpose. The alkoxy group having 1 to 18 carbon atoms is preferably an alkoxy group having 1 to 10 carbon atoms, more preferably an alkoxy group having 1 to 6 carbon atoms, and particularly preferably an alkoxy group having 1 to 3 carbon atoms.

Examples of a ring structure formed by linking R¹ and R² together include a phenyl group.

Examples of the halogen atom of Y include a fluorine atom, a chlorine atom, a bromine atom, and an iodine atom.

Examples of the electron-withdrawing group include a halogen group (e.g., a chloro group, and a bromo group), a trifluoromethyl group, a nitro group, a sulfo group, a carboxyl group, an alkoxy carbonyl group (e.g., a methoxy carbonyl group and an ethoxy carbonyl group), and a formyl group.

A curing activity of an epoxy resin can be enhanced even more by using the electron-withdrawing group as a substituent.

A method for synthesizing the compound is not particularly limited and may be appropriately selected depending on the intended purpose. In the case where n is 1 or 2, examples of the method include a method where aluminium alkoxide and 6-diketone, which corresponds to β-keto enolate anion, are allowed to react, followed by mixing the resultant with aryl silanol, which corresponds to the segment of —O—Si-[Ph(Y)m]₃, in a manner that n in General Formula (1) is to be the desired number.

In the case where n is 3, examples of the method include a method where aluminium alkoxide and aryl silanol, which corresponds to the segment of —O—Si-[Ph(Y)m]₃, are mixed in a manner that n in General Formula (1) is to be the desired number.

### (Cationic Curing Agent)

A cationic curing agent of the present invention includes at least porous particles and the compound [compound represented by General Formula (1)] of the present invention, and may further include other components according to the necessity.

In the cationic curing agent, the compound represented by General Formula (1) is held in the porous particles.

For example, the compound represented by General Formula (1) is held inside pores of the porous particles.

The cationic curing agent is a so-called latent curing agent.

An amount of the compound represented by General Formula (1) held in the porous particles in the cationic curing agent is not particularly limited and may be appropriately selected depending on the intended purpose.

### <Porous Particles>

The porous particles are not particularly limited and may be appropriately selected depending on the intended purpose, as long as the porous particles are particles having many pores. Examples of the porous particles include porous organic resin particles formed of an organic resin and porous inorganic particles formed of an inorganic compound.

The average pore diameter of pores of the porous particles is not particularly limited and may be appropriately selected depending on the intended purpose. The average pore diameter is preferably 1 nm to 300 nm, and more preferably 5 nm to 150 nm.

### <<Porous Organic Resin Particles>>

The porous organic resin particles are not particularly limited and may be appropriately selected depending on the intended purpose, as long as the porous organic resin particles are porous particles formed of an organic resin.

The organic resin is not particularly limited and may be appropriately selected depending on the intended purpose. The organic resin is preferably a polyurea resin. Specifically, a material of the porous organic resin particles preferably includes at least a polyurea resin.

The material of the porous organic resin particles may further include a vinyl resin.

### <<<Polyurea Resin>>>

The polyurea resin is a resin including a urea bond in a molecule of the resin thereof.

For example, the polyurea resin constituting the porous organic resin particles can be obtained by polymerizing a polyfunctional isocyanate compound in an emulsion. The polyurea resin may include, in the resin thereof, a bond that is derived from an isocyanate group and is not a urea bond.

### —Polyfunctional Isocyanate Compound—

The polyfunctional isocyanate compound is a compound including, in a molecule thereof, 2 or more isocyanate groups, preferably 3 isocyanate groups. More preferable examples of such a trifunctional isocyanate compound include: a TMP adduct represented by General Formula (2) below obtained by allowing 1 mole of trimethylol is propane and 3 moles of a diisocyanate compound to react together; an isocyanurate body represented by General Formula (3) below obtained by self-condensing 3 moles of a diisocyanate compound; and a burette body represented by General Formula (4) below obtained by, among 3 moles of a diisocyanate compound, condensing 1 mole of the remained diisocyante to diisocyanate urea obtained from 2 moles of the diisocyanate.

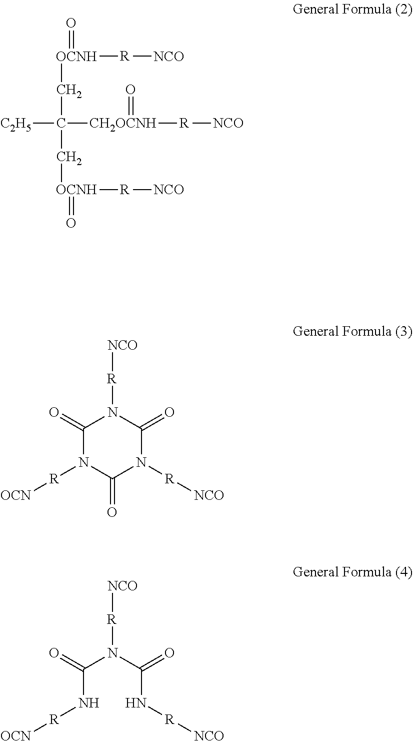

In General Formulae (2) to (4), a substituent R is a site in which isocyanate groups are removed from the diisocyanate compound. Specific examples of such a diisocyanate compound include toluene 2,4-diisocyanate, toluene 2,6-diisocyanate, m-xylene diisocyanate, hexamethylene diisocyanate, hexahydro-m-xylenediisocyanate, isophorone diisocyanate, and methylene diphenyl-4,4′-diisocyanate.

### <<<Vinyl Resin>>>

The vinyl resin is a resin obtained through polymerization of a radical polymerizable vinyl compound.

The vinyl resin improves mechanical characteristics of the porous organic resin particles. Use of the vinyl resin can impart thermal response to a cationic curable composition at the time of curing, particularly, sharp thermal response in a low temperature region.

For example, the vinyl resin can be obtained by adding a radical polymerizable vinyl compound to an emulsion including a polyfunctional isocyanate compound, and performing radical polymerization of the radical polymerizable vinyl compound at the same time as when the polyfunctional isocyanate compound is polymerized in the emulsion.

### —Radical Polymerizable Vinyl Compound—

The radical polymerizable vinyl compound is a compound including a radical polymerizable carbon-carbon unsaturated bond in a molecule thereof.

The radical polymerizable vinyl compound include a so-called monofunctional radical polymerizable compound and polyfunctional radical polymerizable compound.

The radical polymerizable vinyl compound preferably include a polyfunctional radical polymerizable compound. Use of the polyfunctional radical polymerizable compound easily realize sharp thermal response at a low temperature region. From the point as mentioned, the radical polymerizable vinyl compound preferably includes a polyfunctional radical polymerizable compound in an amount of 30% by mass or greater, more preferably 50% by mass or greater.

Examples of the monofunctional radical polymerizable compound include a monofunctional vinyl-based compound (e.g., styrene and methyl styrene), and a monofunctional (meth)acrylate-based compound (e.g., butyl acrylate).

Examples of the polyfunctional radical polymerizable compound include a polyfunctional vinyl-based compound (e.g., divinyl benzene, and divinyl adipate), and a polyfunctional (meth)acrylate-based compound (e.g., 1,6-hexanediol diacrylate, and trimethylol propane triacrylate).

Among the above-listed examples, a polyfunctional vinyl-based compound, particularly divinyl benzene, can be used in view of latent characteristics and thermal response.

Note that, a polyfunctional radical polymerizable compound may be formed from a polyfunctional vinyl-based compound and a polyfunctional (meth)acrylate-based compound. Use of the polyfunctional vinyl-based compound and the polyfunctional (meth)acrylate-based compound in combination can obtain an effect of varying thermal response or introducing a reactive functional group.

A blending amount of the radical polymerizable vinyl compound is not particularly limited and may be appropriately selected depending on the intended purpose. The amount thereof is preferably 1 part by mass to 80 parts by mass and more preferably 10 parts by mass to 60 parts by mass relative to 100 parts by mass of the polyfunctional isocyanate compound.

The average particle diameter of the porous organic resin particles is not particularly limited and may be appropriately selected depending on the intended purpose. The average particle diameter thereof is preferably 0.5 μm to 20 μm, more preferably 1 μm to 10 μm, and particularly preferably 1 μm to 5 μm.

### <<Porous Inorganic Particles>>

The porous inorganic particles are not particularly limited and may be appropriately selected depending on the intended purpose, as long as the porous inorganic particles are porous particles formed of an inorganic compound.

Examples of a material of the porous inorganic particles include silicon oxide, aluminium silicate, aluminium oxide, zirconium oxide, potassium oxide, calcium oxide, titanium oxide, calcium borate, sodium borosilicate, sodium oxide, and phosphoric acid salt. The above-listed examples may be used alone or in combination.

Examples of the porous inorganic particles include porous silica particles, porous alumina particles, porous titania particles, porous zirconia particles, and zeolite. The above-listed examples may be used alone or in combination.

The average particle diameter of the porous inorganic particles is not particularly limited and may be appropriately selected depending on the intended purpose. The average particle diameter thereof is preferably 50 nm to 5,000 μm, more preferably 250 nm to 1,000 μm, and particularly preferably 500 nm to 200 μm.

### <<Surfaces of Porous Particles>>

The porous particles preferably include a reaction product of a silane coupling agent on surfaces thereof for the purpose of enhancing latent characteristics.

The reaction product is obtained by reacting a silane coupling agent.

The reaction product is present on surfaces of the porous particles.

It is assumed that the porous particles holding therein the compound represented by General Formula (1) have the compound represented by General Formula (1) on surfaces as well as inside of the porous particles because of the structure thereof.

In the case where an alicyclic epoxy resin having high reactivity is used as a cationic curable component in the below-mentioned cationic curable composition, therefore, the cationic curable composition including the cationic curing agent significantly increases viscosity over time.

Therefore, the compound represented by General Formula (1) present on surfaces of the porous particles is preferably deactivated by a silane coupling agent.

As described below, the silane coupling agent is classified into two types.

A first type of the silane coupling agent is a silane coupling agent where an alkoxysilyl group in a molecule of the silane coupling agent is allowed to react with the active compound represented by General Formula (1) held in the porous particles to generate a polymer chain having a siloxane structure and a surface of the active compound is covered with the polymer chain to reduce the activity. Examples of the above-mentioned type of the silane coupling agent include an alkylalkoxy silane coupling agent including an alkyl group. Specific examples thereof include methyltrimethoxysilane, n-propyltrimethoxysilane, and hexyltrimethoxysilane.

A second type of the silane coupling agent is an epoxy silane coupling agent where an epoxy group in a molecule of the silane coupling agent is allowed to react with the active compound represented by General Formula (1) held in the porous particles to generate an epoxy polymer chain and a surface of the active compound is covered with the epoxy polymer chain to reduce the activity. Specific examples thereof include 2-(3,4-epoxycyclohexypethyltrimethoxysilane (KBM-303, available from Shin-Etsu Chemical Co., Ltd.) and 3-glycidoxypropyltrimethoxysilane (KBM-403, available from Shin-Etsu Chemical Co., Ltd.).

### <Production Method of Cationic Curing Agent>

A production method of the cationic curing agent is not particularly limited and may be appropriately selected depending on the intended purpose.

In the case where porous organic resin particles are used as porous particles, for example, usable is a method where porous organic resin particles holding therein a component other than the compound represented by General Formula (1) are produced, followed by removing the component, and filling the porous resin particles with the compound represented by General Formula (1). A method for producing the porous organic resin particles holding therein the component other than the compound represented by General Formula (1) is not particularly limited and may be appropriately selected depending on the intended purpose. For example, the production can be performed with reference to JP-A Nos. 2009-203477, 2012-188596, and 2009-221465.

In the case where porous inorganic particles are used as porous particles, moreover, usable is a method where the porous inorganic particles are filled with the compound represented by General Formula (1). Specifically, for example, the production can be performed with reference to JP-A No. 2013-100382.

Moreover, a method for forming a reaction product of a silane coupling agent on surfaces of the porous particles can be performed with reference to JP-A No. 2016-056274.

### (Cationic Curable Composition)

The cationic curable composition of the present invention includes at least a cationic curable component and a cationic curing agent. The cationic curable composition preferably further includes an organic silane compound and may further include other components according to the necessity.

### <Cationic Curable Component>

The cationic curable component is not particularly limited and may be appropriately selected depending on the intended purpose, as long as the cationic curable component is an organic material that can be cured through cationic curing. Examples of the cationic curable component include an epoxy resin, an oxetane compound, and a vinyl ether resin.

### <<Epoxy Resin>>

The epoxy resin is not particularly limited and may be appropriately selected depending on the intended purpose. Examples of the epoxy resin include a glycidyl ether-based epoxy resin and an alicyclic epoxy resin.

For example, the glycidyl ether-based epoxy resin may be in the state of a liquid or a solid. The epoxy equivalent of the glycidyl ether-based epoxy resin is typically about 100 to about 4,000, and the glycidyl ether-based epoxy resin preferably includes two or more epoxy groups in a molecule thereof. Examples of the glycidyl ether-based epoxy resin include a bisphenol A-based epoxy resin, a bisphenol F-based epoxy resin, a phenol novolac resin-based epoxy resin, a cresol novolac resin-based epoxy resin, and an ester-based epoxy resin. Among the above-listed examples, a bisphenol A-based epoxy resin is preferably used in view of resin characteristics. Moreover, the above-listed epoxy resins may include monomers and oligomers.

The alicyclic epoxy resin is not particularly limited and may be appropriately selected depending on the intended purpose. Examples of the alicyclic epoxy resin include vinyl cyclopentadiene dioxide, vinyl cyclohexhexene mono- or di- oxide, dicyclopentadiene oxide, epoxy-[epoxy-oxaspiro C₈₋₁₅ alkyl]-cyclo C₅₋₁₂ alkane (e.g., 3,4-epoxy-1-[8,9-epoxy-2,4-dioxaspiro[5.5]undecan-3-yl]-cyclohexane), 3,4-epoxycyclohexylmethyl-3′,4′-epoxycyclohexane carbonate, epoxy C₅₋₁₂ cycloalkyl C₁₋₃ alkyl-epoxy C₅₋₁₂ cycloalkane carboxyrate (e.g., 4,5-epoxycyclooctylmethyl-4′,5′-epoxycyclooctanecarboxylate), and bis(C₁₋₃ alkylepoxy C₅₋₁₂ cycloalkyl C₁₋₃alkyl)dicaraboxylate bis(2-methyl-3,4-epoxycyclohexylmethyDadipate).

As the alicyclic epoxy resin,
3,4-epoxycyclohexylmethyl-3′,4′-epoxycyclohexanecarboxylate [product name: CELLOXIDE #t2021P, available from Daicel Corporation, epoxy equivalent: 128 to 140] is preferably used because a commercial product thereof is readily available.

Note that, in the list of the examples above, C₈₋₁₅, C₅₋₁₂, and C₁₋₃ respectively mean having 8 to 15 carbon atoms, having 5 to 12 carbon atoms, and having 1 to 3 carbon atoms, and indicate that there is a margin in a structure of a compound.

Examples of the structural formula of the alicyclic epoxy resin are presented below.

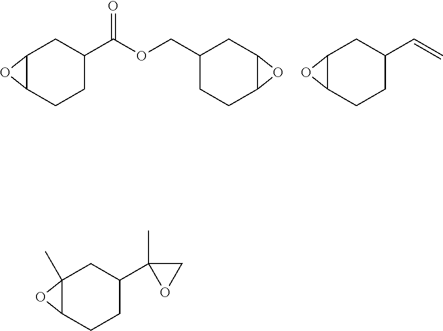

### <<Oxetane Compound>>

An exothermic peak can be made sharp by using the oxetane compound in combination with the epoxy resin in the cationic curable composition.

Examples of the oxetane compound include 3-ethyl-3-hydroxymethyloxetane, 1,4-bis{[(3-ethyl-3-oxetanyl)methoxy]methyl}benzene, 4,4′-bis[(3-ethyl-3-oxetanyl)methoxymethyl]biphenyl, 1,4-benzenedicarboxylic acid bis[(3-ethyl-3-oxetanyl)]methyl ester, 3-ethyl-3-(phenoxymethyl)oxetane, 3-ethyl-3-(2-ethylhexloxymethyl)oxetane, di[1-ethyl(3-oxetanyl)]methyl ether, 3-ethyl-3-{[3-(triethoxysilyl)propoxy]methyl}oxetane, oxetanylsilsesquioxane, and phenol novolac oxetane.

An amount of the cationic curable component in the cationic curable composition is not particularly limited and may be appropriately selected depending on the intended purpose. The amount is preferably 30% by mass to 99% by mass, more preferably 50% by mass to 98% by mass, and particularly preferably 70% by mass to 97% by mass.

Note that, the amount is an amount of non-volatile components of the cationic curable composition. The definition of the amount is the same hereinafter.

In the present specification, a numeral range specified using “A to B” is a rage including the lower limit (A) and the upper limit (B). Specifically, the range of “30% by mass to 99% by mass” is identical to the range of “30% by mass or greater but 99% by mass or less.”

### <Cationic Curing Agent>

The cationic curing agent is the cationic curing agent of the present invention.

An amount of the cationic curing agent in the cationic curable composition is not particularly limited and may be appropriately selected depending on the intended purpose. The amount is preferably 1 part by mass to 70 parts by mass, and more preferably 1 part by mass to 50 parts by mass, relative to 100 parts by mass of the cationic curable component. When the amount is less than 1 part by mass, curing performance may be low. When the amount is greater than 70 parts by mass, resin properties (e.g., flexibility) of a cured product may be not desirable.

### <Organic Silane Compound >

As disclosed in the paragraphs 0007-0010 of JP-A No. 2002-212537, the organic silane compound has a function of initiating cationic polymerization of an epoxy resin with working together with aluminium chelate held in a latent curing agent.

An effect of accelerating curing of a cationic curable component can be obtained by using the cationic curing agent and the organic silane compound in combination also in the cationic curable composition.

Examples of the organic silane compound include an aryl silanol compound and a silane coupling agent.

Examples of such an organic silane compound include a highly steric hindered silanol compound and a silane coupling agent including 1 to 3 lower alkoxy groups in a molecule thereof. Note that, a group reactive to a functional group of the cationic curable component, such as a vinyl group, a styryl group, an acryloyloxy group, a methacryloyloxy group, an epoxy group, an amino group, and a mercapto group, may be included in a molecule of the silane coupling agent. A coupling agent including an amino group or a mercapto group however can used only when the amino group or the mercapto group does not substantially capture generated cation species at the time of cationic curing.

### <<Aryl Silanol Compound>>

For example, the aryl silanol compound is represented by General Formula (A) below.

(Ar) mSi (OH)n General Formula (A)

In General Formula (A), m is 2 or 3, preferably 3, the sum of m and n is 4, and Ar is an aryl group that may include a substituent.

The aryl silanol compound represented by General Formula (A) above is a mono-ol compound or a diol compound.

Ar in General Formula (A) is an aryl group that may include a substituent.

Examples of the aryl group include a phenyl group, a naphthyl group (e.g., a 1-naphthyl group and a 2-naphthyl group), an anthracenyl group (e.g., a 1-anthracenyl group, a 2-anthracenyl group, a 9-anthracenyl group, and a benzo[a]-9-anthracenyl group), a phenanyl group (e.g., a 3-phenanyl group and a 9-phenanyl group), a pyrenyl group (e.g., a 1-pyrenyl group), an azulenyl group, a fluorenyl group, a biphenyl group (e.g., a 2-biphenyl group, a 3-biphenyl group, and a 4-biphenyl group), a thienyl group, a furyl group, a pyrrolyl group, an imidazolyl group, and a pyridyl group. Among the above-listed examples, a phenyl group is preferable in view of availability and cost thereof. The number “m” of “Ar”s are all identical or different but “Ar” s are preferably all identical in view of availability.

The above-listed aryl groups may each have, for example, 1 to 5 substituents.

Examples of the substituent include an electron-withdrawing group and an electron-donating group.

Examples of the electron-withdrawing group include a halogen group (e.g., a chloro group and a bromo group), a trifluoromethyl group, a nitro group, a sulfo group, a carboxyl group, an alkoxycarbonyl group (e.g., a methoxycarbonyl group and an ethoxycarbonyl group), and a formyl group.

Examples of the electron-donating group include an alkyl group (e.g., a methyl group, an ethyl group, and a propyl group), an alkoxy group (e.g., a methoxy group and an ethoxy group), a hydroxyl group, an amino group, a monoalkylamino group (e.g., a monomethylamino group), and a dialkylamino group (e.g., a dimethylamino group).

Specific examples of a phenyl group including a substituent(s) include a 2-methylphenyl group, a 3-methylphenyl group, a 4-methylphenyl group, a 2,6-dimethylphenyl group, a 3,5-dimethylphenyl group, a 2,4-dimethylphenyl group, a 2,3-dimethylphenyl group, a 2,5-dimethylphenyl group, a 3,4-dimethylphenyl group, a 2,4,6-trimethylphenyl group, a 2-ethylphenyl group, and a 4-ethylphenyl group.

Note that, use of an electron-withdrawing group as a substituent can increase acidity of a hydroxyl group of a silanol group. Use of an electron-donating group as a substituent can decrease acidity of a hydroxyl group of a silanol group. Therefore, curing activity can be controlled by a substituent.

Each of the number “m” of “Ar”s may include a different substituent, but preferably has an identical substituent in view of readily availability. Moreover, part of “Ar”s may include substituents and the rest of “Ar”s may not have substituents.

The aryl silanol compound is preferably a compound represented by General Formula (B) because the compound has excellent properties and synthesis thereof is relatively easy.

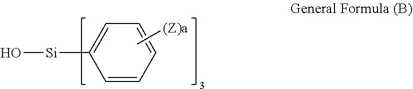

In General Formula (B), Z is an electron-withdrawing group and a is an integer of 0 to 5.

### <<Silane Coupling Agent>>

The silane coupling agent is a compound including 1 to 3 lower alkoxy groups in a molecule thereof. The silane coupling agent may include, in a molecule thereof, a group reactive to a functional group of a thermoset resin, such as a vinyl group, a styryl group, an acryloyloxy group, a methacryloyloxy group, an epoxy group, an amino group, and a mercapto group. Note that, a coupling agent including an amino group or a mercapto group can be used when the amino group or mercapto group does not substantially capture cationic species generated because the latent curing agent for use in the present invention is a cationic curing agent.

Examples of the silane coupling agent include vinyltris(β-methoxyethoxy)silane, vinyltriethoxysilane, vinyltrimethoxysilane, γ-styryltrimethoxysilane, γ-methacryloxypropyltrimethoxysilane, γ-acryloxypropyltrimethoxysilane, β-(3,4-epoxycyclohexyDethyltrimethoxysilane, γ-glycidoxypropyltrimethoxysilane, γ-glycidoxypropylmethyldiethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, γ-mercaptopropyltrimethoxysilane, and γ-chloropropyltrimethoxysilane.

An amount of the organic silane compound in the cationic curable composition is not particularly limited and may be appropriately selected depending on the intended purpose. The amount is preferably 50 parts by mass to 500 parts by mass and more preferably 100 parts by mass to 300 parts by mass, relative to 100 parts by mass of the cationic curing agent.

### EXAMPLES

Examples of the present invention will be described hereinafter, but these Examples shall not be construed as to limit the scope of the present invention.

### Example 1-1

### <Synthesis of Compound A>

A 100 mL 3-necked flask equipped with a stirrer, a thermometer, and a nitrogen inlet tube and purged with N₂ was charged with 5.0 g (20.3 mmol) of aluminium-sec-butoxide available from Tokyo Chemical Industry Co., Ltd. and 20 g of cyclohexane. To the resultant mixture, 16.83 g (60.9 mmol) of triphenyl silanol available from KANTO CHEMICAL CO., LTD. was added at room temperature with stirring, followed by heating to 50° C. to react for 5 hours. After completing the reaction, precipitated solids were collected through vacuum filtration and then washed with cyclohexane. Then, the resultant was dried at 25° C. for 24 hours under reduced pressure, to thereby obtain 17.1 g of transparent solid Compound A.

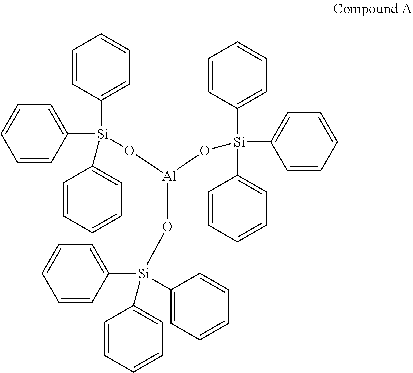

### Example 1-2

<Synthesis of Compound B>A 100 mL 3-necked flask equipped with a stirrer, a thermometer, and a nitrogen inlet tube and purged with N2 was charged with 5.0 g (20.3 mmol) of aluminium-sec-butoxide available from Tokyo Chemical Industry Co., Ltd., 10 g of cyclohexane, and 2 g of ethyl acetate. To the resultant, a solution obtained by dissolving 2.032 g (20.3 mmol) of acetyl acetone available from Tokyo Chemical Industry Co., Ltd. in 10 g of cyclohexane was added for 10 minutes with stirring at room temperature. The resultant mixture was allowed to react for 10 minutes with stirring, followed by adding 11.22 g (40.6 mmol) of triphenyl silanol available from KANTO CHEMICAL CO., LTD. Thereafter, the resultant was heated to 50° C. and was allowed to react for 5 hours. After completing the reaction, precipitated solids were collected through vacuum filtration and then washed with cyclohexane. Then, the resultant was dried at 25° C. for 24 hours under reduced pressure, to thereby obtain 13.5 g of white solid Compound B.

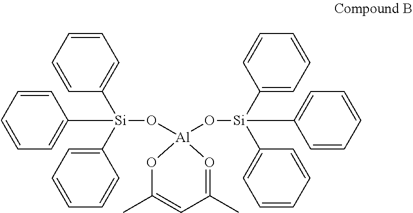

### Example 1-3

### <Synthesis of Compound C>

White solid Compound C (9.9 g) was obtained in the same manner as in Example 1-2, except that the amount of the acetyl acetone was changed to 4.065 g (40.6 mmol) and the amount of the triphenyl silanol was changed to 5.61 g (20.3 mmol).

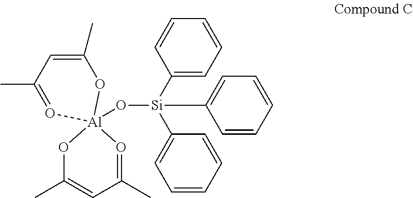

### Example 1-4

### <Synthesis of Compound D>

A 100 mL 3-necked flask equipped with a stirrer, a thermometer, and a nitrogen inlet tube and purged with N₂ was charged with 5.0 g (18.2 mmol) of aluminium ethylacetoacetate diisopropylate (ALCH) available from Kawaken Fine Chemicals Co., Ltd. and 20 g of cyclohexane. To the resultant mixture, 10.1 g (36.5 mmol) of triphenyl silanol available from KANTO CHEMICAL CO., LTD. was added at room temperature with stirring, followed by heating to 76° C. to react for 2 hours while removing the cyclohexane and desorbed isopropanol. During the reaction, replenishment of the lost cyclohexane was performed about twice. After completing the reaction, removal of the cyclohexane was continued for about 1 hour, followed by cooling. Then, the resultant was dried at 30° C. for 48 hours under reduced pressure, to thereby obtain 12.5 g of white solid Compound D.

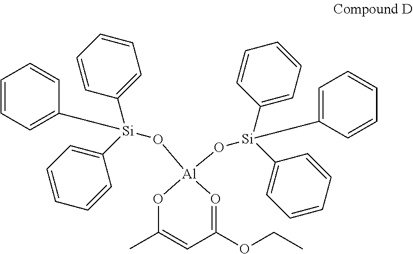

### Production Example 1

### <Production of Porous Particles 1-1>

Porous Particles 1-1 were produced according to the method disclosed as Example 1 in JP-A No. 2009-203477.

Porous Particles 1-1 formed of a polyurea resin held therein aluminium monoacetylacetonate bis(ethylacetoacetate).

### Production Example 2

### <Production of Porous Particles 1-2>

Porous Particles 1-2 were produced according to the method disclosed as Example 1 in JP-A No. 2009-221465.

Porous Particles 1-2 formed of a polyurea resin and a vinyl resin held therein aluminium monoacetylacetonate bis(ethylacetoacetate).

### Production Example 3

### <Production of Porous Particles 1-3>

Porous Particles 1-3 were produced according to the method disclosed as Example 9 in JP-A No. 2009-221465.

Porous Particles 1-3 formed of a polyurea resin and a vinyl resin held therein aluminium monoacetylacetonate bis(ethylacetoacetate).

### Production Example 4

### <Production of Porous Particles 1-4>

Particles 1-4 were produced according to the method disclosed as Example 1 in JP-A No. 2012-188596.

Porous Particles 1-4 formed of a polyurea resin held therein aluminium monoacetylacetonate bis(ethylacetoacetate).

### Usage Example 1

Porous silica (product name: SUNSPHERE H-32, available from AGC Si-Tech Co., Ltd.), which was used in Example 6 of JP-A No. 2013-100382, was provided as Porous Particles 1-5.

### Example 2-1

### <Production of Porous Particles 2-1>

First, a 100 mL recovery flask was charged with 3.0 g of Porous Particles 1-1 and 30 g of ethyl acetate, and the resultant mixture was stirred for 1 hour at room temperature. Thereafter, the resultant was filtered under reduced pressure to wash porous particles. Note that, the washing was the operation for removing aluminium monoacetylacetonate bis(ethylacetoacetate) from Porous Particles 1-1.

Thereafter, the porous particles obtained as the filtration residue was placed in a 100 mL 3-necked flask equipped with a N₂ inlet tube. To the flask, 3.0 g of Compound A and 30 g of ethyl acetate were added and the resultant mixture was stirred for 15 minutes at 50° C. in an oil bath with introducing N₂ gas. Then, the temperature of the oil bath was increased to 70° C., and the mixture was stirred to remove ethyl acetate to thereby concentrate the liquid to make Compound A held inside Porous Particles 1-1. After completing the condensation, the resultant was cooled and left to stand at room temperature for 24 hours. Thereafter, 60 g of cyclohexane was added to the resultant and the resultant mixture was stirred for 1 hour. Thereafter, filtration was performed under reduced pressure, followed by washing with 30 g of cyclohexane. Again, filtration was performed under reduced pressure, and the filtration residue was dried for 24 hours at 30° C. under reduced pressure to thereby produce porous particles 2-1 holding therein Compound A.

### Examples 2-2 to 2-7

### <Production of Porous Particles 2-2 to 2-7>

Porous Particles 2-2 to 2-7 each holding the compound therein were produced in the same manner as in Example 2-1, except that the compound to be held inside the porous particles was changed to the compound presented in Table 1.

### Example 2-8

### <Production of Porous Particles 2-8>

First, a 100 mL 3-necked flask was charged with 3.0 g of Porous Particles 1-5 and dried for 3 hours at 100° C. under reduced pressure. After cooling the resultant, the flask was transferred into an oil bath, and a N₂ inlet tube and a thermometer were set to the flask. Then, 3.0 g of Compound A and 30 g of ethyl acetate were added with introducing N₂ gas and the resultant mixture was stirred for 15 minutes at 50° C. Thereafter, the temperature of the oil bath was set to 70° C. and ethyl acetate was removed with stirring to condense the liquid, to thereby make Compound A held inside Porous Particles 1-5. After completing the condensation, the resultant was cooled and left to stand for 24 hours at room temperature. To the resultant, 60 g of cyclohexane was added and the resultant mixture was stirred for 1 hour. Thereafter, filtration was performed under reduced pressure, followed by washing with 30 g of cyclohexane. Again, filtration was performed under reduced pressure, and the filtration residue was dried for 24 hours at 30° C. under reduced pressure to thereby produce Porous Particles 2-8 holding therein Compound A.

### Comparative Example 2-1

### <Production of Porous Particles 3-1>

Porous Particles 3-1, which were Porous Particles 1-1 holding therein Aluminium Chelate D, were produced in the same manner as in Example 2-1, except that 1.32 g of Aluminium Chelate D (a 24% isopropanol solution of aluminium monoacetylacetonate bis(ethylacetoacetate)) available from Kawaken Fine Chemicals Co., Ltd. was used instead of Compound A.

### Comparative Examples 2-2 to 2-4

### <Production of Porous Particles 3-2 to 3-4>

Porous Particles 3-2 to 3-4 each holding therein Aluminium Chelate D were produced in the same manner as in Comparative Example 2-1, except that each of Porous Particles 1-2 to 1-4 were used instead of Porous Particles 1-1.

### Comparative Example 2-5

### <Production of Porous Particles 3-5>

Porous Particles 3-5 holding therein Aluminium Chelate D were produced in the same manner as in Example 2-8, except that 1.32 g of Aluminium Chelate D (a 24% isopropanol solution of aluminium monoacetylacetonate bis(ethylacetoacetate)) available from Kawaken Fine Chemicals Co., Ltd. was used instead of Compound A.

The porous particles and compounds used in Examples 2-1 to 2-8 are presented in Table 1.

The porous particles and compounds used in Comparative Examples 2-1 to 2-5 are presented in Table 2.

TABLE 1

| | | Ex. | | Ex. | | Ex. | | |
|---|---|---|---|---|---|---|---|---|
| | Ex. 2-1 | 2-2 | Ex. 2-3 | 2-4 | Ex. 2-5 | 2-6 | Ex. 2-7 | Ex. 2-8 |
| Obtained | 2-1 | 2-2 | 2-3 | 2-4 | 2-5 | 2-6 | 2-7 | 2-8 |
| porous | | | | | | | | |
| particles | | | | | | | | |
| Used | 1-1 | 1-2 | 1-3 | 1-4 | 1-3 | 1-3 | 1-3 | 1-5 |
| porous | | | | | | | | |
| particles | | | | | | | | |
| Used | A | A | A | A | B | C | D | A |
| compound | | | | | | | | |

TABLE 2

| | Comp. | Comp. | Comp. | Comp. | Comp. |
|---|---|---|---|---|---|
| | Ex. 2-1 | Ex. 2-2 | Ex. 2-3 | Ex. 2-4 | Ex. 2-5 |
| Obtained | 3-1 | 3-2 | 3-3 | 3-4 | 3-5 |
| porous | | | | | |
| particles | | | | | |
| Used porous | 1-1 | 1-2 | 1-3 | 1-4 | 1-5 |
| particles | | | | | |
| Used | Al | Al | Al | Al | Al |
| compound | Chelate D | Chelate D | Chelate D | Chelate D | Chelate D |

In Table 2, Al Chelate D denotes Aluminium Chelate D [aluminium monoacetylacetonate bis(ethylacetoacetate)] available from Kawaken Fine Chemicals Co., Ltd., which is the same hereinafter.

### Example 3-1

### <Preparation of Cationic Curable Composition A-1>

YL980 (a bisphenol A-type epoxy resin, available from Mitsubishi Chemical Corporation) (100 parts by mass), 5 parts by mass of triphenyl silanol available from KANTO CHEMICAL CO., LTD., and 2 parts by mass of Porous Particles 2-1 produced in Example 2-1 were blended to prepare Cationic Curable Composition A-1.

### Examples 3-2 to 3-8

### (Preparation of Cationic Curable Compositions A-2 to A-8)

Cationic Curable Compositions A-2 to A-8 were prepared in the same manner as in Example 3-1, except that the porous particles for use were changed as presented in Table 3.

### Comparative Examples 3-1 to 3-5

### <Preparation of Cationic Curable Compositions B-1 to B-5>

Cationic Curable Compositions B-1 to B-5 were prepared in the same manner as in Example 3-1, except that Porous Particles 3-1 to 3-5 produced in Comparative Examples 2-1 to 2-5 were used as presented in Table 4.

The details of Examples 3-1 to 3-8 above are summarized in Table 3.

The details of Comparative Examples 3-1 to 3-5 above are summarized in Table 4.

TABLE 3

| | | | | Ex. | Ex. | Ex. | Ex. | | Ex. | |
|---|---|---|---|---|---|---|---|---|---|---|
| | | | Ex. 3-1 | 3-2 | 3-3 | 3-4 | 3-5 | Ex. 3-6 | 3-7 | Ex. 3-8 |
| Cationic curable | | | A-1 | A-2 | A-3 | A-4 | A-5 | A-6 | A-7 | A-8 |
| composition | | | | | | | | | | |
| Amount | YL980 | | 100 | | | | | | | |
| (mass | Triphenol | | 5 | | | | | | | |
| parts) | silanol | | | | | | | | | |
| | Porous | 2-1 | 2 | — | — | — | — | — | — | — |
| | particle | 2-2 | — | 2 | — | — | — | — | — | — |
| | | 2-3 | — | — | 2 | — | — | — | — | — |
| | | 2-4 | — | — | — | 2 | — | — | — | — |
| | | 2-5 | — | — | — | — | 2 | — | — | — |
| | | 2-6 | — | — | — | — | — | 2 | — | — |
| | | 2-7 | — | — | — | — | — | — | 2 | — |
| | | 2-8 | — | — | — | — | — | — | — | 2 |

TABLE 4

| | | | Comp. | Comp. | Comp. | Comp. | Comp. |
|---|---|---|---|---|---|---|---|
| | | | Ex. | Ex. | Ex. | Ex. | Ex. |
| | | | 3-1 | 3-2 | 3-3 | 3-4 | 3-5 |
| Cationic curable | | | B-1 | B-2 | B-3 | B-4 | B-5 |
| composition | | | | | | | |
| Amount | YL980 | | 100 | | | | |
| (mass | Triphenyl | | 5 | | | | |
| parts) | silanol | | | | | | |
| | Porous | 3-1 | 2 | — | — | — | — |
| | particles | 3-2 | — | 2 | — | — | — |
| | | 3-3 | — | — | 2 | — | — |
| | | 3-4 | — | — | — | 2 | — |
| | | 3-5 | — | — | — | — | 2 |

### <Evaluation of Cationic Curing>

Each of the cationic curable compositions prepared in Examples 3-1 to 3-8 and Comparative Examples 3-1 to 3-5 in an amount of 5 mg was placed in an aluminium container having a diameter of 5 mm for DSC6200, followed by performing differential scanning calorimetry. The exothermic peak temperature of the DSC measurement was evaluated.

As well known in the art, cationic curing is an exothermic reaction, and an exothermic peak temperature obtained in differential scanning calorimetry reflects curing performance of cationic curing and the lower exothermic peak temperature is more desirable.

The conditions for the differential scanning calorimetry are as follows.

### <<Measuring Conditions>>

Heating rate: 10 ° C./min (25° C. to 300° C.)
N₂ gas: 100 mL/min

The results are presented in Tables 5 and 6.

TABLE 5

| | Ex. | Ex. | Ex. | Ex. | Ex. | Ex. | Ex. | Ex. |
|---|---|---|---|---|---|---|---|---|
| | 3-1 | 3-2 | 3-3 | 3-4 | 3-5 | 3-6 | 3-7 | 3-8 |
| Cationic | A-1 | A-2 | A-3 | A-4 | A-5 | A-6 | A-7 | A-8 |
| curable | | | | | | | | |
| composition | | | | | | | | |
| Final porous | 2-1 | 2-2 | 2-3 | 2-4 | 2-5 | 2-6 | 2-7 | 2-8 |
| particles | | | | | | | | |
| Used porous | 1-1 | 1-2 | 1-3 | 1-4 | 1-3 | 1-3 | 1-3 | 1-5 |
| particles | | | | | | | | |
| Used | A | A | A | A | B | C | D | A |
| compound | | | | | | | | |
| Peak | 128.4 | 97.5 | 90.4 | 103.4 | 93.4 | 96.2 | 89.4 | 95.8 |
| temperature | | | | | | | | |
| [° C.] | | | | | | | | |

TABLE 6

| | Comp. | Comp. | Comp. | Comp. | Comp. |
|---|---|---|---|---|---|
| | Ex. 3-1 | Ex. 3-2 | Ex. 3-3 | Ex. 3-4 | Ex. 3-5 |
| Cationic | B-1 | B-2 | B-3 | B-4 | B-5 |
| curable | | | | | |
| composition | | | | | |
| Final porous | 3-1 | 3-2 | 3-3 | 3-4 | 3-5 |
| particles | | | | | |
| Used porous | 1-1 | 1-2 | 1-3 | 1-4 | 1-5 |
| particles | | | | | |
| Used | Al | Al | Al | Al | Al |
| compound | Chelate D | Chelate D | Chelate D | Chelate D | Chelate D |
| Peak | 148.2 | 118.2 | 107.3 | 125.4 | 109.6 |
| temperature | | | | | |
| [° C.] | | | | | |

It was found from Tables 5 and 6 that all of the porous particles holding therein the compound of the present invention realized low temperature of the peak temperature when comparisons were made with the identical porous particles (comparison between Example 3-1 and Comparative Example 3-1, comparison between Example 3-2 and Comparative Example 3-2, comparison between Example 3-3 and Comparative Example 3-3, comparison between Example 3-4 and Comparative Example 3-4, and comparison between Example 3-8 and Comparative Example 3-5). Specifically, curing performance improved with the porous particles holding therein the compound of the present invention (cationic curing agent).

Moreover, it was found from the comparison of Examples 3-3 and 3-5 to 3-7 with Comparative Example 3-3 that all of the compounds of the present invention realized low peak temperatures.

### Example 4-1

### <Production of Porous Particles 4-1>

To 9 g of cyclohexane, 1.0 g of n-propyltrimethoxysilane (KBM-3033, available from Shin-Etsu Chemical Co., Ltd.) was dissolved to prepare a surface deactivation treatment liquid. To the treatment liquid, 1.0 g of Porous Particles 2-1 produced in Example 2-1 were added. The resultant mixture was stirred for 20 hours at 30° C. Thereafter, filtration was performed under reduced pressure with washing with 10 g of cyclohexane to separate the porous particles. The collected porous particles were dried under reduced pressure for 6 hours at 40° C. to thereby produce surface-treated Porous Particles 4-1.

### Examples 4-2 to 4-8

### <Production of Porous Particles 4-2 to 4-8>

Surface-treated Porous Particles 4-2 to 4-8 were produced in the same manner as in Example 4-1, except that the used porous particles were changed as presented in Table 7.

### Comparative Examples 4-1 to 4-5

### <Production of Porous Particles 5-1 to 5-5>

Surface-treated Porous Particles 5-1 to 5-5 were produced in the same manner as in Example 4-1, except that the used porous particles were changed as presented in Table 8.

TABLE 7

| | | Ex. | | Ex. | | Ex. | | |
|---|---|---|---|---|---|---|---|---|
| | Ex. 4-1 | 4-2 | Ex. 4-3 | 4-4 | Ex. 4-5 | 4-6 | Ex. 4-7 | Ex. 4-8 |
| Obtained | 4-1 | 4-2 | 4-3 | 4-4 | 4-5 | 4-6 | 4-7 | 4-8 |
| porous | | | | | | | | |
| particles | | | | | | | | |
| Used | 2-1 | 2-2 | 2-3 | 2-4 | 2-5 | 2-6 | 2-7 | 2-8 |
| porous | | | | | | | | |
| particles | | | | | | | | |

TABLE 8

| | Comp. | Comp. | Comp. | Comp. | Comp. |
|---|---|---|---|---|---|
| | Ex. 4-1 | Ex. 4-2 | Ex. 4-3 | Ex. 4-4 | Ex. 4-5 |
| Obtained | 5-1 | 5-2 | 5-3 | 5-4 | 5-5 |
| porous | | | | | |
| particles | | | | | |
| Used porous | 3-1 | 3-2 | 3-3 | 3-4 | 3-5 |
| particles | | | | | |

### Example 5-1

### <Preparation of Cationic Curable Composition C-1>

YL980 (bisphenol A-type epoxy resin, available from Mitsubishi Chemical Corporation) (60 parts by mass), 15 parts by mass of CELLOXIDE 2021P available from Daicel Corporation, 25 parts by mass of ARON OXETANE OXT-221 available from TOAGOSEI CO., LTD., 5 parts by mass of triphenyl silanol available from KANTO CHEMICAL CO., LTD., and 2 parts by mass of Porous Particles 4-1 produced in Example 4-1 were blended to prepare Cationic Curable Composition C-1.

### Examples 5-2 to 5-8

### <Preparation of Cationic Curable Composition C-2 to C-8>

Cationic Curable Compositions C-2 to C-8 were prepared in the same manner as in Example 5-1, except that the used porous particles were changed as presented in Table 9.

### Comparative Examples 5-1 to 5-5

### <Preparation of Cationic Curable Compositions D-1 to D-5>

Cationic Curable Compositions D-1 to D-5 were prepared in the same manner as in Example 5-1, except that Porous Particles 5-1 to 5-5 produced in Comparative Examples 4-1 to 4-5 were used as presented in Table 10.

The details of Examples 5-1 to 5-8 are summarized in Table 9 below.

The details of Comparative Examples 5-1 to 5-5 are summarized in Table 10 below.

TABLE 9

| | | | Ex. | Ex. | Ex. | Ex. | Ex. | Ex. | Ex. | Ex. |
|---|---|---|---|---|---|---|---|---|---|---|
| | | | 5-1 | 5-2 | 5-3 | 5-4 | 5-5 | 5-6 | 5-7 | 5-8 |
| Cationic curable | | | C-1 | C-2 | C-3 | C-4 | C-5 | C-6 | C-7 | C-8 |
| composition | | | | | | | | | | |
| Amount | YL980 | | 60 | | | | | | | |
| (mass parts) | 2021P | | 15 | | | | | | | |
| | OXT-221 | | 25 | | | | | | | |
| | Triphenyl | | 5 | | | | | | | |
| | silanol | | | | | | | | | |
| | Porous | 4-1 | 2 | — | — | — | — | — | — | — |
| | particles | 4-2 | — | 2 | — | — | — | — | — | — |
| | | 4-3 | — | — | 2 | — | — | — | — | — |
| | | 4-4 | — | — | — | 2 | — | — | — | — |
| | | 4-5 | — | — | — | — | 2 | — | — | — |
| | | 4-6 | — | — | — | — | — | 2 | — | — |
| | | 4-7 | — | — | — | — | — | — | 2 | — |
| | | 4-8 | — | — | — | — | — | — | — | 2 |

TABLE 10

| | | | Comp. | Comp. | Comp. | Comp. | |
|---|---|---|---|---|---|---|---|
| | | | Ex. | Ex. | Ex. | Ex. | Comp. Ex. |
| | | | 5-1 | 5-2 | 5-3 | 5-4 | 5-5 |
| Cationic curable | | | D-1 | D-2 | D-3 | D-4 | D-5 |
| composition | | | | | | | |
| Amount | YL980 | | 60 | | | | |
| (mass | 2021P | | 15 | | | | |
| parts) | OXT-221 | | 25 | | | | |
| | Triphenyl | | 5 | | | | |
| | silanol | | | | | | |
| | Porous | 5-1 | 2 | — | — | — | — |
| | particles | 5-2 | — | 2 | — | — | — |
| | | 5-3 | — | — | 2 | — | — |
| | | 5-4 | — | — | — | 2 | — |
| | | 5-5 | — | — | — | — | 2 |

### <Evaluation of Cationic Curing>

Each of the cationic curable compositions prepared in Examples 5-1 to 5-8 and Comparative Examples 5-1 to 5-5 in an amount of 5 mg was placed in an aluminium container having a diameter of 5 mm for DSC6200, followed by performing differential scanning calorimetry. The exothermic peak temperature of the DSC measurement was evaluated in the same manner as above.

### <Evaluation of Storage Stability of Cationic Curable Composition>

Each of the cationic curable compositions prepared in Examples 5-1 to 5-8 and Comparative Examples 5-1 to 5-5 was stored in a sealed container for 1 day (24 hours) at 25° C., and the reaction rate during the storage was estimated by comparing the exothermic values of differential scanning calorimetry before and after the storage. The results are presented in Tables 11 and 12 together with the results of curing performance.

Note that, the reaction rate is determined by the following formula. Reaction rate (%)=100×[(exothermic value before storage)-(exothermic value after storage)]/(exothermic value before storage)

TABLE 11

| | Ex. | Ex. | Ex. | Ex. | Ex. | Ex. | Ex. | Ex. |
|---|---|---|---|---|---|---|---|---|
| | 5-1 | 5-2 | 5-3 | 5-4 | 5-5 | 5-6 | 5-7 | 5-8 |
| Cationic | C-1 | C-2 | C-3 | C-4 | C-5 | C-6 | C-7 | C-8 |
| curable | | | | | | | | |
| composition | | | | | | | | |
| Final porous | 4-1 | 4-2 | 4-3 | 4-4 | 4-5 | 4-6 | 4-7 | 4-8 |
| particles | | | | | | | | |
| Porous | 2-1 | 2-2 | 2-3 | 2-4 | 2-5 | 2-6 | 2-7 | 2-8 |
| particles | | | | | | | | |
| before surface | | | | | | | | |
| treatment | | | | | | | | |
| Used porous | 1-1 | 1-2 | 1-3 | 1-4 | 1-3 | 1-3 | 1-3 | 1-5 |
| particles | | | | | | | | |
| Used | A | A | A | A | B | C | D | A |
| compound | | | | | | | | |
| Peak | 103.6 | 83.5 | 75.1 | 87.6 | 78.9 | 81.2 | 77.8 | 86.2 |
| temperature | | | | | | | | |
| [° C.] | | | | | | | | |
| Reaction rate | 0.3 | 1.5 | 5.9 | 3.2 | 4.9 | 3.6 | 4.8 | 6.1 |
| [%] | | | | | | | | |

TABLE 12

| | Comp. | Comp. | Comp. | Comp. | Comp. |
|---|---|---|---|---|---|
| | Ex. 5-1 | Ex. 5-2 | Ex. 5-3 | Ex. 5-4 | Ex. 5-5 |
| Cationic | D-1 | D-2 | D-3 | D-4 | D-5 |
| curable | | | | | |
| composition | | | | | |
| Final porous | 5-1 | 5-2 | 5-3 | 5-4 | 5-5 |
| particles | | | | | |
| Porous | 3-1 | 3-2 | 3-3 | 3-4 | 3-5 |
| particles | | | | | |
| before | | | | | |
| surface | | | | | |
| treatment | | | | | |
| Used porous | 1-1 | 1-2 | 1-3 | 1-4 | 1-5 |
| particles | | | | | |
| Used | Al | Al | Al | Al | Al |
| compound | Chelate D | Chelate D | Chelate D | Chelate D | Chelate D |
| Peak | 112.3 | 102.1 | 86.3 | 108.5 | 85.3 |
| temperature | | | | | |
| [° C.] | | | | | |
| Reaction | 0.2 | 1.3 | 6.1 | 2.5 | 4.1 |
| rate [%] | | | | | |

It was found from Tables 11 and 12 that all of the porous particles holding therein the compound of the present invention realized low temperature of the peak temperature when comparisons were made with the identical porous particles (comparison between Example 5-1 and Comparative Example 5-1, comparison between Example 5-2 and Comparative Example 5-2, comparison between Example 5-3 and Comparative Example 5-3, comparison between Example 5-4 and Comparative Example 5-4, and comparison between Example 5-8 and Comparative Example 5-5). Specifically, curing performance improved with the porous particles holding therein the compound of the present invention (cationic curing agent).

Moreover, it was found from the comparison of Examples 5-3 and 5-5 to 5-7 with Comparative Example 5-3 that all of the compounds of the present invention realized low peak temperatures.

Furthermore, there was hardly any difference in the reaction rate for the storage of 25° C. and 1 day between the present invention and Comparative Examples. It can be said that the porous particles of the present invention can improve curing performance without impairing storage stability. Specifically, the porous particles holding therein the compound of the present invention (cationic curing agent) improved without impairing latent characteristics.

Note that, an evaluation of storage stability of the cationic curable composition was not performed on Examples 3-1 to 3-8 and Comparative Examples 3-1 to 3-5. This was because storage stability thereof was not very good due to the composition of the cationic curable component. In Examples 3-1 to 3-8 and Comparative Examples 3-1 to 3-5, however, it was the same that the porous particles holding therein the compound of the present invention (cationic curing agent) improved without impairing latent characteristics.

The compound of the present invention is suitably used for a cationic curing agent that can improve curing performance without impairing latent characteristics.

The cationic curing agent of the present invention is suitably used as a latent curing agent of a cationic curable composition.

The cationic curable composition of the present invention is suitably used as a cationic curable composition of latent curing.

What is claimed is:

1. A compound represented by General Formula (1) below: 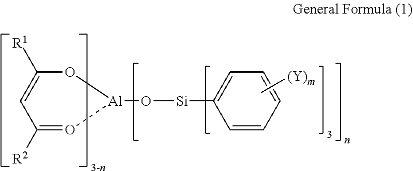
where, in General Formula (1), R¹ is an alkyl group having 1 to 18 carbon atoms, a halogenated alkyl group having 1 to 18 carbon atoms, or a phenyl group that may include a substituent, R² is an alkyl group having 1 to 18 carbon atoms, a halogenated alkyl group having 1 to 18 carbon atoms, an alkoxy group having 1 to 18 carbon atoms, or a phenyl group that may include a substituent, where R¹ and R² may be linked together to form a ring, Y is a halogen atom, an alkyl group having 1 to 18 carbon atoms, a halogenated alkyl group having 1 to 18 carbon atoms, or a phenyl group that may include a substituent, m is an integer of 0 to 5, where Ys may be identical or different when m is 2 or more, and n is an integer of 1 to 3.

2. A cationic curing agent comprising:
porous particles; and
the compound according to claim 1, held in the porous particles.

3. The cationic curing agent according to claim 2,
wherein a material of the porous particles includes a polyurea resin.

4. The cationic curing agent according to claim 3,
wherein the material of the porous particles further includes a vinyl resin.

5. The cationic curing agent according to claim 2,
wherein the porous particles are porous inorganic particles.

6. The cationic curing agent according to claim 2,
wherein surfaces of the porous particles include a reaction product of a silane coupling agent.

7. A cationic curable composition comprising:
a cationic curable component; and
the cationic curing agent according to claim 2.

8. The cationic curable composition according to claim 7, further comprising a compound represented by General Formula (B) below: 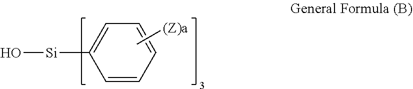
where in General Formula (B), Z is an electron-withdrawing group and a is an integer of 0 to 5. {N5541985}
